(19) United States
(12) Patent Application Publication
(10) Pub. No.: US 2020/0143758 A1
(43) Pub. Date: May 7, 2020

(54) LCD with Wide Color Gamut and Adjustable Colors

(71) Applicant: Sun Lu, Mount Hamilton, CA (US)

(72) Inventor: Sun Lu, Mount Hamilton, CA (US)

(21) Appl. No.: 15/994,650

(22) Filed: May 31, 2018

(51) Int. Cl. G09G 3/34; G09G 3/36

(52) U.S. Cl. CPC G09G 3/3413; G09G 3/3607; G09G 2320/0242; G09G 2320/0653; G09G 2320/0666

(57) ABSTRACT

A method includes providing an LCD comprising an LED backlight with light emitting diodes that emit lights of red color, green color, and blue color. The method also includes operatively connecting the light emitting diodes to a backlight driver and a dimming signal processing unit such that the backlight driver provides control instructions to the light emitting diodes. The method also has controlling the three color light emitting diodes to provide a good image quality and some color effects for the images displayed on the LCD screen.

### CROSS REFERENCE TO RELATED PATENT APPLICATIONS

This patent application claims priority to U.S. Provisional Patent Application No. 62/516,981 to Sun Lu filed on Jun. 8, 2017, which is incorporated by reference.

### FIELD OF THE INVENTION

This patent application is directed to an improved LCD (Liquid Crystal Display) that can provide a very wide color gamut and adjustable colors. This improved LCD can provide special color effects with simple LED color adjustment sequences. The wide color gamut and special color effects are suitable for televisions, monitors, digital advertisement signage, gaming displays, and other LCD applications that benefit from improved color quality.

### BACKGROUND OF THE RELATED ART

### 1. The LCD Color Gamut

In 1931, CIE (International Commission of Illumination) came up with a way to specify the human visual perception of light. It uses Y (illumination), and x, y (chromaticity) to describe the brightness and the color of the light. For example, in specifying various colors, the chromaticity values of the white color are near (x, y)=(0.333, 0.333). For the red color, the x value is near 0.6. For the green color, the y value is near 0.5. For the blue color, both x and y values are around 0.15. This is called the CIE 1931 Color Space.

In 1953, the NTSC (National Television System Committee) came up with a standard for the red, green, and blue colors displayed on a color television, called the NTSC Color Gamut Standard. Using the CIE 1931 Color Space, the chromaticity values of the primary colors of this standard are listed below:
Red primary color (x, y)=(0.67, 0.33)
Green primary color (x, y)=(0.21, 0.71)
Blue primary color (x, y)=(0.14, 0.08)
   FIG. 1 shows the NTSC Color Gamut Standard in the CIE 1931 Color Space.

With this standard, the image displayed on the television would have very good color quality. However, at the time, the CRTs (Cathode Ray Tubes) used for televisions could not meet this NTSC color gamut standard.

One of the major problems with LCDs is the color gamut. When white LEDs (Light Emitting Diodes) replaced CCFLs (Cold Cathode Fluorescent Lamps) for LCD backlights, this problem became more serious. In general, commercial LCDs on the market can provide a color gamut to about 70% of the NTSC standard. As a result, the color saturation of the image displayed on the screen is below standard.

The root cause of this issue is the color spectrum of the backlight used to illuminate the LCD. Currently, white color LEDs are used as the light source in LCD backlights. FIG. 2 shows the emitted light spectrum of the white LED, comparing it with the transmission spectrums of the red, green, and blue color filters of the LCD.

In the blue region, the spectrum of the LED light and the filter matches very well. However, in the green to red region, the LED light has a broad spectrum and does not match to the green and red color filters. As a result, the chromaticity values of the green and red primary colors are below the NTSC standard. For example, the R. G. B primary colors displayed on a conventional 19″ LCD have the chromaticity values shown below.
Red primary color (x, y)=(0.639, 0.346)
Green primary color (x, y)=(0.324, 0.627)
Blue primary color (x, y)=(0.154, 0.054)

Comparing these values to the NTSC color gamut standard, the chromaticity values for the Red and Green primary colors are shifted toward the white. This causes poor color saturation of the green and red primary colors displayed on the LCD screen. However, the blue spectrum of the LED light is narrow and matches to the blue color filter very well. Thus, the chromaticity values of the blue primary color match the NTSC standard very well.

In order to improve the color gamut, a new optical material based on Quantum Dots technology was introduced recently. This material contains nanocrystal phosphors that can convert the light spectrum to the desirable spectrum. FIG. 3 shows the LED backlight spectrum using a Nanosys quantum-dot enhancement film (QDEF). The figure shows that the spectrum of the LED backlight is improved significantly in the green and red region. With this spectrum, the color gamut of the LCD can be significantly closer to the 100% level of the NTSC standard.

There are two minor disadvantages with using Quantum Dots films to improve the LCD color. First, the cost of the film is high, especially for large size LCDs. This can increase the cost of the large size LCD televisions. Second, the film reduces the screen brightness. Thus, a brighter backlight with more power consumption is needed to achieve the required LCD screen brightness.

### 2. The LCD Color Temperature Adjustment

With LCD monitors for professional applications (for example, film editing and graphic design), the color temperature of the display can be adjusted such that the image on the screen can reproduce the color tone of the real scene with high fidelity. Before the advent of the LCD monitor, the “color calibrated” monitors using CRTs (cathode ray tubes) were available. However, when LCDs replaced CRT technology, it became more difficult to provide such color calibration function.

Each pixel of the LCD has three sub-pixels in red (R), green (G) and blue (B) colors. Most commercial LCDs have 8-bit grey scale for each sub-pixel which can create 256 grey levels (from 0 to 255). The brightness of each sub-pixel is the highest at a grey level of 255. At a grey level of 0, the sub-pixel is totally dark. So, the white color occurs when the grey levels of the R, G, B sub-pixels are all at 255, and the black color occurs at grey levels of 0. Therefore, by controlling the grey levels of the R, G, B sub-pixels, the pixel can have 256×256×256=16,777, 216 different colors at various combinations of the grey levels

Current LCD monitors allow the user to select from two to three pre-determined color temperature settings, for example, 5,000 K, 6,500 K, and 9,300 K. These numbers represent the color temperature (in Kelvin) of the “white” displayed on the screen. As the color temperature is adjusted to a higher number, the “white” color displayed on the screen is shifted more toward the bluish color.

For LCDs, the method for adjusting the color temperature is based on limiting the grey levels of one or two primary colors. For example, if the grey levels of the red primary color are limited from 0 to 150, the white color is set with the grey levels of the R, G, B sub-pixels at 150, 255, 255. Since the red primary color is not at its highest brightness level, the white color appears bluish, which increases the color temperature of the display. However, the maximum number of the colors displayed on the screen is reduced to 151×256×256=9,895,936 instead of the original 16,777,216 colors. This may degrade the image quality. In cases where the grey level of some primary color is reduced to 64 levels or below, the image displayed on the screen will show some lines between the two neighboring grey levels, which can severely degrade the image quality.

### SUMMARY OF THE INVENTION

According to a first aspect of the present disclosure, there is provided an improved LCD with wide color gamut and adjustable colors. This improved LCD can be used in televisions and monitors with very good color quality of the images displayed on the screen. It can also create special color effects for certain display applications such as advertisements and gaming.

In yet another aspect of the present disclosure, this improved LCD uses a backlight with LEDs (Light Emitting Diodes) that emit lights in red, green and blue (R, G, B) colors. The LEDs emitting the light of red, green, and blue colors are organized in three separate groups. Each group consists of LEDs that emit the light of the same color.

In yet another aspect of the present disclosure, this improved LCD has a backlight driver that has three LED driving channels. Each driving channel drives a group of LEDs of a color. In addition, there are three dimming controls which can adjust (or dim) the amount of light emitted from each color LED independently.

With these features, the emitted light from the LED backlight is a mixture of the red, green, and blue colors at various ratios. For example, if the lights emitted from the green and blue LEDs are dimmed down, the backlight color becomes more reddish. As a result, the white color displayed on the LCD becomes more reddish and the color temperature of the display is reduced. If the light levels of the green and blue colors are dimmed down to zero level, the images displayed on the LCD are totally in red color.

### BRIEF DESCRIPTION OF THE FIGURES

The foregoing and other objects, features and advantages of the invention will be apparent from the following more particular description of preferred embodiments of the invention, as illustrated in the accompanying drawings in which like reference characters refer to the same parts throughout different views. The drawings are not meant to limit the invention to particular mechanisms for carrying out the invention in practice, but rather, the drawings are illustrative of certain ways of performing the invention. Others will be readily apparent to those skilled in the art.

FIG. 1 shows the NTSC Color Gamut Standard in the CIE 1931 Color Space.

FIG. 2 shows the power density spectra of the light emitted from the backlight using white LEDs comparing to the optical transmission of the red, green, and blue color filters of the LCD panels.

FIG. 3 shows the improved power density spectra of the light emitted from the white LEDs by using a quantum-dot enhancement film (QDEF) in front of the white LEDs.

FIG. 4 shows the system architecture of this invented LCD. It shows the LCD glass panel, the backlight behind the panel, the LED Strip with the red, green, and blue LEDs, the backlight driver, and the dimming signal processing unit.

FIG. 5 shows one of the ways to implement the special LED strip used in this embodiment of the LCD.

FIG. 6 shows another way to implement the special LED strip used in this embodiment of the LCD.

FIG. 7 shows the power density spectra of the emitted light from the red, green, and blue LEDs compared to the optical transmission of the red, green, and blue color filters of the LCD panels. It shows that the wavelength at the peak power density matches well to the transmission wavelength range of the color filters of the LCD.

FIG. 8 shows a way to further improve the color gamut of the LCD by shifting the red color filter transmission further to the red color region.

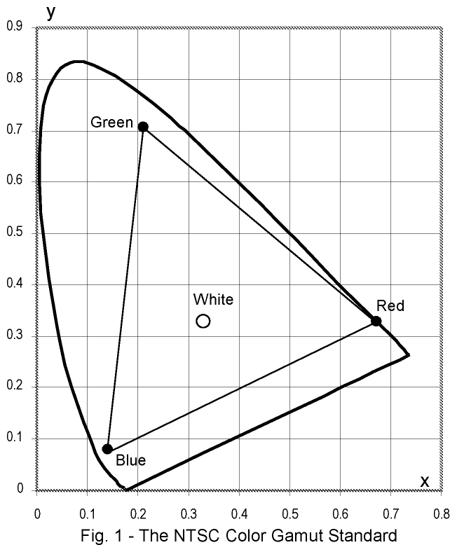

### DETAILED DESCRIPTION OF THE PREFERRED EMBODIMENTS

This present disclosure is directed to an improved LCD (Liquid Crystal Display) that can provide very wide color gamut and adjustable colors. Thus, it is suitable to be used for televisions, monitors and other LCD applications with superior color quality.

In addition, this improved LCD can provide special color effects with some simple LED color adjustment sequences. These special color effects are suitable for digital signs for advertisements and also monitors for gaming with certain special effects.

This improved LCD uses a backlight with LEDs (Light Emitting Diodes) that emit lights in red, green and blue (R, G, B) colors. The LEDs are organized in three separate groups. Each group consists of the LEDs that emit the light of the same color. Thus, one group has the LEDs emitting the red light, another group has the LEDs emitting the green light, and the third group has the LEDs emitting the blue light.

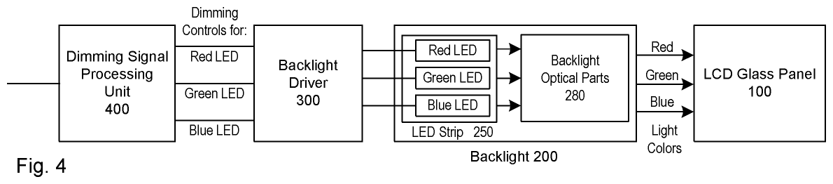

FIG. 4 shows the system architecture of this embodiment of the LCD. It has the LCD Glass Panel (100) with the red, green, and blue sub-pixels. Behind the LCD is the backlight (200) with the LED strip (250) as the light source and the backlight optical parts (280) which include the light guide and some optical films for the backlight.

The LED strip contains the LEDs emitting lights in red color, green color, and blue color (red LEDs, green LEDs, and blue LEDs) organized as three separate groups. The backlight driver (300) has three LED driving channels. Each driving channel drives a group of LEDs emitting light of one color. In addition, there are three dimming control circuits that can adjust the amount of light emitted from each color's LEDs independently.

With these features, the emitted light from the backlight is a mixture of the red, green, and blue colors at various ratios. For example, if the lights emitted from the green and blue LEDs are dimmed down, the emitted light from the backlight becomes more reddish. As a result, the white color displayed on the LCD becomes more reddish and the color temperature of the display is reduced. If the light levels of the green and blue colors are dimmed down to zero level, the images displayed on the LCD are totally red in color.

The structure of the Backlight (200) is the same as the backlights used in current LCDs. The difference is the LED strip which uses LEDs emitting lights in red, green, and blue colors instead of the LEDs emitting light in white color (white LEDs).

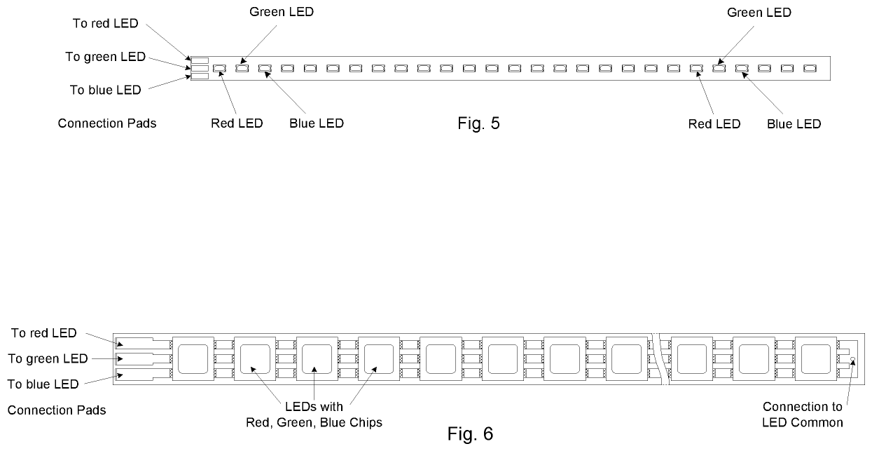

There are several ways to implement this special LED strip. FIG. 5 shows one of the ways. It uses separate red, green, and blue LEDs. From the left side, the 1st LED is red, the 2nd LED is green, and the 3rd LED is blue. This sequence repeats after that. Since the red, green, and blue LEDs are connected separately, the LED strip has 3 connection pads at the left side of the strip for connecting to the 3 driving channels of the Backlight Driver (300). Besides that, there is a common connection pad which can be at the back side of the strip or at the right end of the strip.

FIG. 6 shows another way to implement the LED strip. The LED used here has 3 chips inside. One chip emits red color light, the second chip emits green color light, and the third chip emits blue color light. Each LED has 6 pins for connections to the anodes and the cathodes of the three LED chips in the package.

On the left side of the strip, there are 3 connection pads for connecting to the 3 driving channels of the backlight driver (300). On the right side of the strip, it has the LED common connection. At the back side of this strip, there is a copper trace that connects the LED common to the backlight driver.

Since there are 3 LED chips inside, the size of the LED package is large, which requires a thicker light guide for the backlight. As a result, this type of LED strips are more suitable for backlights used in large size LCDs.

There are other ways to layout the strip using red, green, and blue LEDs. FIG. 5 and FIG. 6 show the fundamental layouts of the LED strip used in this invented LCD.

The Backlight Driver (300) shown in the system architecture has three LED driving channels to drive the red, green and blue LED groups. Each driving channel has its own dimming control that can adjust the amount of light emitted from the red, green, and blue LEDs independently.

In addition, there is a Dimming Signal Processing Unit (400) which can provide the dimming signals to the backlight driver (300) to create some special display features as described in the Summary of the Invention. This dimming signal processing unit can include a CPU (Central Processor Unit) with some memory and other circuits that can process the input signal from the display user to provide the dimming signals to set the needed color temperature and create the special color effects for the displayed images on the screen as described in the advantages of this embodiment of the LCD.

If the embodiment of the LCD is used to replace an LCD currently in use, the dimming signal processing unit can provide one dimming signal to the three dimming controls of the Backlight Driver (300). Thus, this embodiment is fully compatible with LCDs currently in use. However, after converting to this embodiment, the color quality of the images displayed on the screen would improve significantly. In addition, the Dimming Signal Processing Unit (400) can provide the dimming signal either in a DC voltage or a PWM (pulsed width modulation) waveform as it is provided by the display systems using current LCDs.

The following are the three major advantages and special features of this embodiment of the LCD:

First, this embodiment can improve the color gamut to the level of 100% NTSC standard. In fact, from some of the tests we have done, the color gamut may exceed the NTSC standard. As a result, the images displayed will have very good color quality.

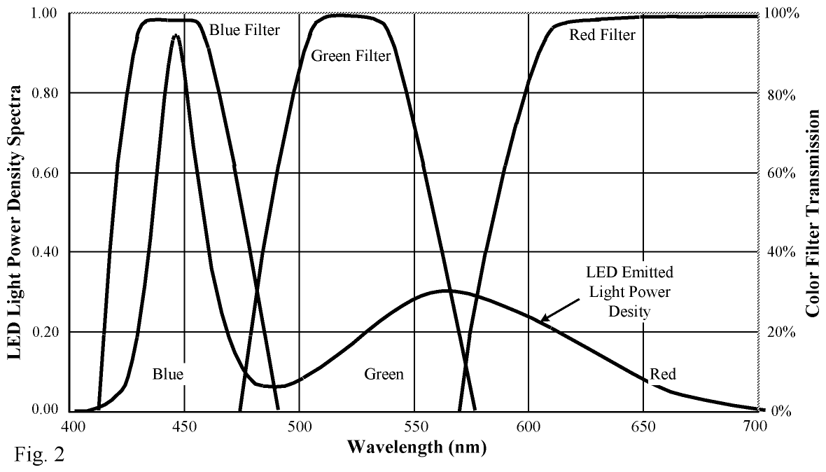

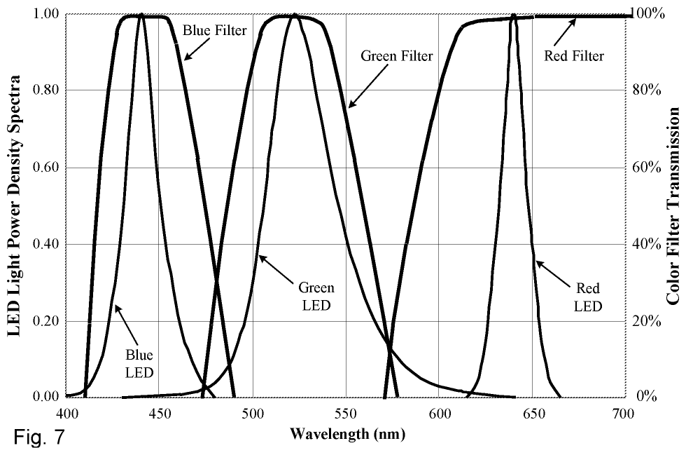

FIG. 7 shows the power density spectra of the emitted light from some red, green, and blue LEDs. Compared to the light emitted from the white LED in FIG. 2, the green and red lights have a much narrower wavelength range. Also, the wavelength at the peak power density matches well to the transmission wavelength range of the green and red color filters of the LCD panel.

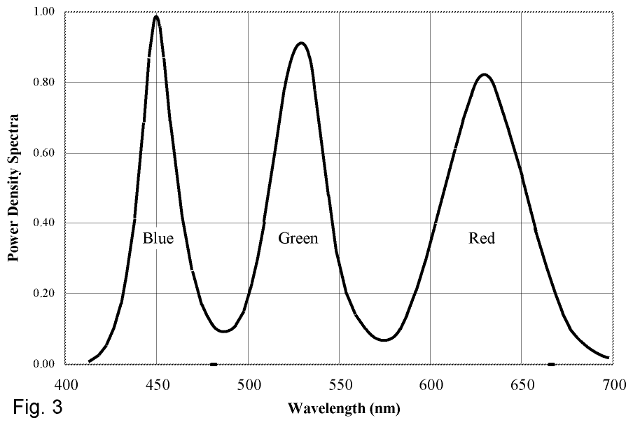

Compared to the improved power density spectra using quantum-dot enhancement film (QDEF) shown in FIG. 3, the power density spectra of the red, green, and blue LEDs is significantly better in the 580 to 620 nm region. As a result, this embodiment of the LCD should have a better color gamut than the LCDs using QDEF.

In the tests of a prototype 15″ LCD using a backlight with red, green, and blue LEDs, we obtain the following chromaticity for the red, green, and blue primary colors displayed on the LCD screen:
Red primary color (x, y)=(0.663, 0.317)
Green primary color (x, y)=(0.218, 0.732)
Blue primary color (x, y)=(0.142, 0.061)

Compared to the NTSC Color Gamut Standard, the red primary color chromaticity matches the NTSC standard closely. In addition, the chromaticity values of the green and blue primary colors slightly exceed the NTSC standard.

With this embodiment of the LCD, it is possible to improve the chromaticity values of the red primary colors beyond the level shown above. For example, as shown in FIG. 7, the transmission spectrum of the red color filter can pass the light emitted from the green LED from 570 nm and beyond. This affects the saturation of the red color displayed on the LCD screen. Since the spectrum of the light emitted from the red LED starts around 620 nm, we can shift the transmission spectrum of the red color filter toward 600 nm to reduce the amount of green light passing through the red color filter.

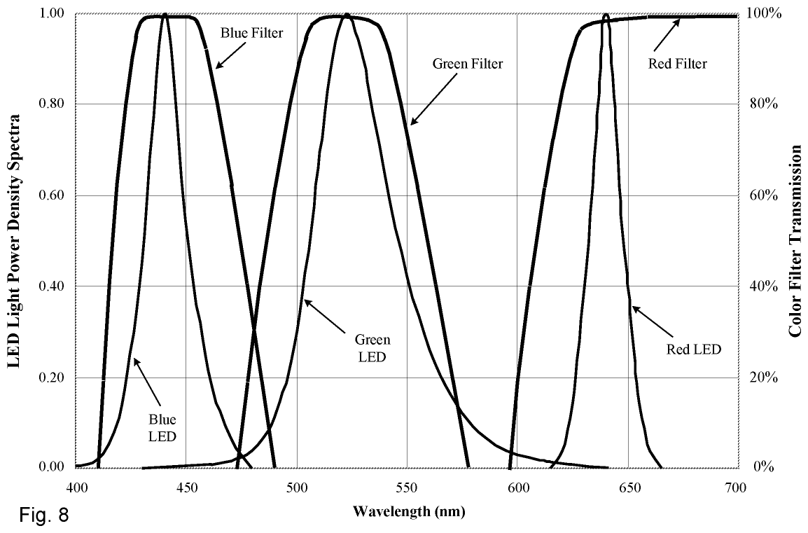

FIG. 8 illustrates this concept by using a red color filter with a transmission spectrum starting at 600 nm. This reduces the amount of green light passing through the red color filter significantly. As a result, the color saturation of the red primary color displayed on the LCD is improved.

The emitted light from the red LED starts around 615 nm and reaches the peak at 640 nm. The chromaticity of the red light at 640 nm is around (x, y)=(0.73, 0.28) which exceeds the NTSC red primary color standard at (x, y)=(0.67, 0.33). In fact, even at 615 nm, the chromaticity is about the same as the NTSC red primary color standard. As a result, the chromaticity values of all the light emitted from the red color LED should exceed the NTSC standard for the red primary color.

Since the amount of green light passing through this red color filter is very small, the red primary color displayed on the LCD screen would have chromaticity values exceeding the NTSC red color chromaticity standard.

The second major advantage is that this embodiment of the LCD can resolve the color temperature adjustment issue of the LCDs currently in use, as it is stated in the BACKGROUND OF THE RELATED ART.

With this embodiment, the color temperature of the “white” displayed on the screen is adjusted by changing the maximum brightness level of the red, green, and blue lights from the red, green, and blue LEDs in the backlight. For example if the color temperature needs to be adjusted to around 6500 K, the maximum brightness level of the light emitted from the red LEDs is reduced such that the emitted light from the backlight shifts toward the bluish color. In the meantime, the grey scale of the R, G, B sub-pixels of the LCD remain to be at 256 levels. As a result, the color temperature adjustment of the LCD does not affect the quality of the image displayed on the screen.

After setting the color temperature, if the LCD screen brightness needs to be reduced, the dimming signals to the red, green, and blue LEDs have to be adjusted to maintain the color temperature. One example is if a user reduces the maximum brightness level of the red LED to 80% in order to achieve a desired color temperature. If the LCD is then used in a nighttime environment, the screen brightness is often dimmed down. If the user dims the screen by a factor of five, the maximum brightness levels set for the red light (80%), the green light (100%) and the blue light (100%) for the desired color temperature must be dimmed down by a factor of five. Thus in this example, the brightness of the red light is dimmed down to 16% of the maximum level, while the blue light and green lights will each be dimmed to 20% of the maximum level. The Dimming Signal Processing Unit (400) described above can adjust the required dimming functions for the red, blue and green LEDs in order to maintain the desired color temperature.

In fact, the better color temperature adjustment of this embodiment is the major advantage against using Quantum Dots films to improve color quality. For LCDs using Quantum Dots films, the color temperature adjustment is still based on limiting the grey levels of one or two red, green, and blue pixels of the LCD. So, it will still affect the quality of the images displayed on the screen.

The third major advantage is that this embodiment of the LCD can provide special display color effects with backlight dimming sequences provided by the Dimming Signal Processing Unit (400) to the Backlight Driver (300). These dimming sequences can be stored in the memory and processed by the CPU, and then sent to the Backlight Driver (300) to create the needed special color effects for the displayed videos and images on the screen.

For some LCD applications, such as advertisements and gaming, these kinds of special color effects on the display increase attractiveness to the viewer. With present LCD display devices, special color effects can be achieved by altering the displayed content using photo and video editing software. However, creating special video content in this manner requires the need to expend additional time, expertise and costs.

With this embodiment of the LCD, certain special color effects can be created easily by changing the color of the backlight. For each display application, the dimming sequence designed for the application can be stored in the Dimming Signal Processing Unit (400) and then played when the video of this application is playing on the screen. In addition, the user can download additional dimming sequences for creating the special color effects for newer advertisements or applications.

Although the descriptions above contain many specificities, these should not be construed as limiting the scope of the embodiment. While this invention has been particularly shown and described with references to a preferred embodiment thereof, it will be understood by those skilled in the art that is made therein without departing from the spirit and scope of the invention as defined by the following claims.

What is claimed is:

1. A method for providing an LCD that can provide very good color quality for the images displayed on the screen and adjustable colors to generate special color effects comprising:
providing an LED backlight that uses one of more LED strips that contains LEDs that emit lights in red, green, and blue colors.
providing a backlight driver that has three LED driving circuits to operate the red, green, and blue LEDs. Each LED driving circuit has its own dimming control circuit to adjust the brightness of the lights emitted from the red, green, and blue LEDs independently.
providing a dimming signal processing unit that can provide three dimming signals to the backlight driver for adjusting the brightness of the red, green, and blue lights emitted from the backlight.

2. The method of claim 1, further comprising an LED backlight containing one or more LED strips that use LEDs emitting lights in red, green, and blue colors.

3. The method of claim 2, further comprising optical parts including a light guide and some optical films to distribute the lights of the red color, the green color, and the blue color emitted from the LED strips evenly over the active area of the LCD.

4. The method of claim 2, further comprising one or more LED strips that contain LEDs emitting lights in red, green, and blue colors. The LEDs emitting the red color light are connected in a group, and the LEDs emitting the green color light are connected in a second group, and the LEDs emitting the blue color light are connected in a third group.

5. The LED strips of claim 4 have three connection pads and one common connection pad. Among the three connection pads, one pad connects to the red LED group, the second pad connects to the green LED group, and the third pad connects to the blue LED group.

6. The method of claim 1 further comprising a backlight driver to drive the LED strips. This backlight driver contains three LED driving circuits. One circuit drives the red LED group, the second circuit drives the green LED group, and the third circuit drives the blue LED group.

7. The backlight driver of claim 6 has three dimming control circuits. One dimming circuit controls the driving current of the red LED group to adjust the brightness of the emitted red light. The second dimming circuit controls the driving current of the green LED group to adjust the brightness of the emitted green light. The third dimming circuit controls the driving current of the blue LED group to adjust the brightness of the emitted blue light.

8. The method of claim 1 further comprising a dimming signal processing unit. This dimming signal processing unit may have a processor with memory and other circuits including a data interface which can connect to the video input to the LCD and other signals. This dimming signal processing unit can process and create the dimming signals and then send the dimming signals to the backlight driver to control the brightness of the red color, green color, and blue color lights emitted from the LED strips for the LCD brightness and color adjustments.

9. The method of claim 1 further providing very good color gamut for the primary colors displayed on the LCD screen. The power density spectra of the emitted light from the red, green, and blue LEDs match fairly well to the optical transmission of the red, green, and blue color filters of the LCD panel. This improves the chromaticity values of the red, greens, and blue primary colors displayed on the LCD screen to the level of NTSC color gamut standard fairly well. As a result, the images displayed on this invented LCD have very good color quality.

10. The method of claim 1 providing a way to further improve the chromaticity values of the red primary color displayed on the LCD screen to the level exceeding the NTSC standard. By shifting the optical transmission of the red filter of the LCD panels currently in use toward a deeper red color region will reduce the amount of light emitted from the green LEDs transmitted through the red filter. Thus the chromaticity values of the red primary color displayed on the screen are nearly the same as the chromaticity values of the light emitted from the red LEDs, which exceed the NTSC standard of the red primary color.

11. The method of claim 1 further comprising a better way of adjusting the color temperature of the white color displayed on the LCD screen. For this invented LCD, the color temperature of the white color displayed on the screen is adjusted by reducing the maximum brightness of a primary color light emitted by the LEDs instead of by reducing the number of grey levels of one of the R, G, B pixels of the LCD. Thus, this new way of color adjustment of the white color does not degrade the quality of the images displayed on the LCD.

12. The better way of adjusting the color temperature of claim 11 uses the dimming signal processing unit to adjust the maximum brightness level of a primary color light emitted from the LEDs. In addition, when the screen brightness of the LCD needs to be adjusted down for viewing the display in darker environments, the dimming signal processing unit will process and provide the proper three dimming signals to the backlight driver to adjust the screen brightness and also maintain the set color temperature of the white color displayed on the screen.

13. The method of claim 1 further comprising of having some special color effects for the videos and images displaying on the LCD screen. These special color effects are created by some dimming signal sequences processed by the dimming signal processing unit of claim 6.

14. The dimming signal processing unit of claim 6 can have some dimming signal sequences, specially designed for certain videos and images, stored in the memory. When these videos and images are playing on the LCD screen, the dimming signal sequences stored in the memory will automatically perform to control the brightness of the red color, green color, and blue color lights emitted from the backlight to provide the special color effects for these videos and images.

15. The stored dimming signal sequences of claim 13 can be updated by loading new dimming signal sequences designed for the new videos and images to be played on the LCD screen. Even if the video and images playing on the LCD screen are the same as before, the dimming signal sequences can still be updated to produce additional or varied attractions for the viewers.
